(19) United States
(12) Patent Application Publication
(10) Pub. No.: US 2019/0359389 A1
(43) Pub. Date: Nov. 28, 2019

(54) SUSTAINABLE AND FLEXIBLE PACKAGING AND PROCESS TO PREPARE SAID PACKAGING

(71) Applicant: Yuri Papp, Sao Paulo (BR)

(72) Inventor: Yuri Papp, Sao Paulo (BR)

(21) Appl. No.: 16/332,134

(22) PCT Filed: Sep. 12, 2017
(86) PCT No.: PCT/BR2017/050270

§ 371 Date: Mar. 11, 2019

(30) Foreign Application Priority Data
Sep. 14, 2016 (BR) BR 10 2016021184

(51) Int. Cl. B65D 33/02; B65D 65/40; B65D 65/02; B32B 27/32; B32B 3/18

(52) U.S. Cl. CPC B65D 33/02; B65D 65/40; B32B 2439/62; B32B 27/32; B32B 3/18; B65D 65/02

(57) ABSTRACT

The present invention relates to a package comprising the composition of at least one flexible film (casing), containing attached internally, externally or between films, a section of blade/plate/plate semirigid material or flexible reinforced (skeleton/soul) perimeter less than the flexible film (casing) that contains it, so that, when the packaging, the union formed of at least two opposite edges, semirigid or flexible material (skeleton/soul), tend to go back to your original form, gives the packaging a predetermined format. This is a particularly flexible, self-sustaining rolled. Such packaging offers a combination of advantages noted in flexible packaging in combination with advantages of rigid packaging, particularly on the possibility of stacking and ease of manufacturing and handling. Still, the present invention refers to a process of preparation of the said package.

### CROSS-REFERENCE TO RELATED APPLICATIONS

This application is a national stage filing of International Patent Application No. PCT/BR2017/050270 filed on Sep. 12, 2017, which claims priority to Brazilian application No. BR 1020160211840 filed on Sep. 14, 2016, both of which are incorporated herein by reference in their entireties.

### FIELD OF THE INVENTION

The present invention relates to a package having at least one flexible film (or casing), having attached internally, externally or between films, a section of blade (or plate) as a semirigid or flexible material reinforced skeleton (or soul), smaller than the perimeter of the flexible film (or casing) that contains it, so that, when formed into packaging, the union formed of at least two opposite edges, the semirigid or flexible material (skeleton/soul) tends to go back to original form, giving the packaging a predetermined format. This packaging is particularly flexible and self-sustaining rolled. Such packaging offers a combination of advantages noted in flexible packaging in combination with advantages of rigid packaging, particularly on the possibility of stacking and ease of manufacturing and handling.

Still, the present invention refers to a process of preparation of the said package.

### BACKGROUND OF THE INVENTION

There are currently different types and models of flexible packaging for solid or liquid products in the food, cosmetic, pet, hygiene and cleaning product industries among others, whose forms of presentation and structure differ according to the product.

One of the major concerns of the market that directly impacts the cost of the final product is the mechanical features of the package, i.e. your capacity and storage of the product form and the possibility of embedding and transport of multiple packages (arranging and stacking), because these products are packed and boxed for shipping between the factories and distribution centers and retail centers, must traverse great distances and, thus, the structure of packages becomes very important and affects the transport type and the volume to be carried at a charge and, therefore, the final cost of the product.

Another very important aspect of the packaging is if and how can the package be stacked and arranged in points of sale (e.g. shelves and counters). In this sense, the format and packing mechanical structure impact the kind of exposure that product experiences at points of sale.

Accordingly, to meet the needs of stacking, emerged on the market the auto-portable packaging (self-sustaining) compiled on the basis of cardboard paper, owned by a company operating under the trade name Tetra Pak (Pully, Switzerland). This packaging allows the filling only in specific lines of your manufacturer, which is a limiting aspect to other packaging industries.

This solution of Tetra Pak presents the features while filling the packaging form (Form Fill Seal), however, due to the different composition materials, does not allow recycling or composting of packaging when discarded.

Another aspect of this solution that is disadvantageous, Tetra Pak doesn't allow packaging of solids or powders and that it only allows stacking if you don't have a lid or curvature at the top (example: carton of milk). And, finally, the structural design allows only small variations in the design, resulting in a few packaging formats, even for different customers and/or different brand products.

Still, it should be mentioned the packaging of stand up pouch-type bags which are auto-portable, i.e., self-sustaining, but have the disadvantage that almost every filling machine, in your vast majority Form Fill Seal (FFS), do not allow or accept such constructiveness. So, you don't have the filling of the product while the packaging (FFS), forcing the bottling of the product after packing formation, setting up separate operating two steps.

In addition to the inconvenience of filling not concomitant with the formation of the packing bag type (stand-up pouch), this won't admit to stacking for either transport or exhibition in gondola or shelf displays at the point of retail. And finally, conformation aesthetics hardly admit variation in your format.

It is noteworthy that even among the entire universe of packaging possible and known, there are those plastic and flexible packaging produced and understood by a combination of different laminate substrates that are used to aggregate value to them, is to contribute on the aesthetic issues, as it allows the quality and print protection labelling of products, is to increase the barrier properties and reduce costs. One of the characteristics of laminated packaging is the union of two or more flexible films that, according to their properties, will provide the necessary requirements for packaging, the packaging and protection, productivity and transportation and product display in the shelves.

Another feature of the laminates is the possibility of several materials of different properties on a single laminar structure, diversifying the possibilities of application, according to the product being bottled; besides being extremely economical with regard to the relationship of quantity of material used in packaging for quantity of packed product.

However, despite all the advantages of diversification possibility checked on packages, there is a big disadvantage when it comes to mechanical and structural resistance (format) because, due to your flexibility all structural products bottled in laminated packaging are limited to be exposed in a single level without stacking, because packing adopts the structural format of your content.

This type of laminated packaging has some options of the form (e.g., flat bottom pad, “false stand up pouch”, false welds), but all depend on the internal content to set final form of presentation to consumers; and does not allow stacking, as already mentioned.

We highlight below some of the teachings of the prior art referred to in this matter:

The patent document BR 10 2013 027062 8 describes a packaging for fragile foods comprising a tray hard plastic for a bag flexible plastic Thermo-sealable, tray comprising dividers and plastic bag comprising a carrying strap.

Other patent documents as EP 2 374 725 and 5 123 527 also refer to trays made of hard material by flexible film.

Already, the PI 1104357-1 document reveals a could be expected and packing of chemical products composed of two integrated parts, namely, a flexible bag wrap and inner drive, and said the bag is waterproof made of plastic with opening.

Other patent documents as PI 9813081-1, PI 0713108-9 and US 2017/113236 describe packaging also composed a bag or receptacle and flexible internal hard wrap.

Still, the documents of patent 0804308-6, US 2017/113236, PI 8 151 992, WO 2016/120550, US 2012/0106877, U.S. Pat. Nos. 3,249,520 and 5,651,286 refer to rigid packaging or packages made of flexible material, or start from a rigid packaging involve it with flexible film.

Therefore, does not exist in the State of the art solution equivalent to the presented here in this invention that combines technical differentiators, economic advantages with production in scale, at low cost and industrial applicability and safety allies reliability.

### Objectives of the Invention

Thus, it is an objective of the present invention to provide a sustainable and flexible laminated packaging that is integrated in a single composition.

It is also goal of present invention provide a packaging produced with low cost.

Another objective of this invention is to provide a sustainable and flexible laminated packaging that allows your recycling after use.

Another objective of this invention is to provide a sustainable and flexible laminated packaging that allows the packaging of any product type, solid, granulated, liquid or powdered.

Another objective of this invention is to provide a package that can replace the rigid, flexible packaging and paper card, where you put a bag in a box (used for frozen), currently known.

Another objective of this invention is to provide a versatile, capable of meeting any type of industry.

Another objective of this invention is to provide a package capable of stacking.

Another objective of this invention is to provide a flexible packaging with features of a typical rigid packing paper or card and that dispense package, container or inner receptacle.

Is another of the objectives of the present invention provide a package that can be made with the most varied shapes and dimensions.

Is another of the goals also provide a package that can be used universally in Form Fill Seal packaging machines (FFS) where the packaging is formed at the same time as the product is packed, requiring only small adaptations, and therefore a universal and immediate application.

### SUMMARY OF THE INVENTION

The present invention achieves these and other objectives by means of a package which includes:

(1) a structure comprising at least one blade of semirigid or flexible film material (that when at rest tend to go back to the original form), named skeleton/soul;

(2) sheath formed from a flexible material, and preferably at least one flexible film;

The wrapper features perimeter dimensions larger than the dimensions perimeter of the skeleton/soul;

When the packing is mounted with the Union of at least two opposite edges of the casing;

The present invention still hits those and other goals through a process of preparation of the package object of the present invention comprising the following steps:
Select material for preparation of at least one blade that will form the skeleton/soul;
Select material for preparation of the sheath;
positioning at least one blade to form the skeleton/soul into the sheath for overlay;
prepare the packaging with desired format having the sheathing and the skeleton/soul;
promote packing with the closure of at least two opposite edges.

### DESCRIPTION OF DRAWINGS

The present invention is described below in more detail, with reference to the drawings, in which:

FIG. 1 illustrates schematically a plan view of a first implementation of choice of present invention comprising a casing consisting of a flexible laminated substrate incorporating an internal structure formed by a flat blade and boring (skeleton/soul) of more rigid conformation, setting flexible laminated composition and laminated flexible packing forming sustainable and self-sustaining;

FIG. 2 illustrates a cut of the composition of the package object of the present invention, according to a transverse plane of FIG. 1, whereas the skeleton/soul of the outer side to the housing;

FIG. 3 illustrates a cut of a variation in the composition of the package object of the present invention, taken according to a transverse plane of FIG. 1, whereas the skeleton between two wrappers;

FIG. 4 illustrates a cut of the composition of the package object of the present invention, taken according to a transverse plane of FIG. 1, whereas the skeleton/soul of the inner side to the housing;

FIG. 5 illustrates a perspective view of a representation of the package object of the present invention showing circular cross-section or cylindrical format;

FIG. 6 illustrates schematically a plan view of a second implementation of object packing's favorite present invention comprising a skeleton/soul formed by a plurality of blades flat and boring of more rigid conformation and a casing formed from flexible material, setting flexible laminated structure and forming flexible laminated packing self-sustainable and self-sustaining;

FIG. 7 illustrates a cut of FIG. 6 according to a transverse plane, whereas the skeleton/soul formed by a plurality of more rigid blades on the outside of the casing;

FIG. 8 illustrates a cut of FIG. 6 according to a transverse plane, whereas the skeleton/soul between two wrappers;

FIG. 9 illustrates a cut of FIG. 6 according to a transverse plane, whereas the skeleton/soul formed by a plurality of more rigid blades of the inner side of the casing;

FIG. 10 illustrates a perspective view of a representation of the package object of the present invention of quadrangular cross-section formed by closing the composition shown in FIGS. 6 to 9;

FIG. 11 illustrates schematically a plan view of a third preferred implementation object of the present invention packing whose skeleton/soul formed by a flat boring blade more rigid containing creases spaced and arranged in vertical direction of the packaging to be set, surrounded by a sheath formed from a flexible material;

FIG. 12 illustrates a cut of FIG. 11 according to a transverse plane, whereas the skeleton/soul on the outside of the casing;

FIG. 13 illustrates a cut of FIG. 11 according to a transverse plane, whereas the skeleton/soul (1) between two wrappers;

FIG. 14 illustrates a cut of FIG. 11 according to a transverse plane, whereas the skeleton/soul of the inner side of the casing;

FIG. 15 illustrates a perspective view of the package object of the present invention of quadrangular cross-section formed by closing the composition shown in FIGS. 11 to 14;

FIG. 16 illustrates schematically the first variation of construction of the first implementation illustrated in FIGS. 1 favorite to 5 comprising skeletal blades/soul in a rectangular format already mounted on the roll of film-flexible housing;

FIG. 17 illustrates schematically a second variation of the first implementation illustrated in FIGS. 1 favorite to 5 comprising skeletal blades/soul in foursquare format already mounted on the roll of film-flexible housing;

FIG. 18 illustrates schematically a third variation of construction of the first implementation illustrated in FIGS. 1 favorite to 5 comprising skeletal blades/soul in another rectangular format already mounted on the roll of film-flexible housing;

FIG. 19 illustrates schematically a fourth variation of construction of the first implementation illustrated in FIGS. 1 favorite to 5 comprising skeletal/soul blades shaped like a cross already mounted on the roll of film-flexible housing;

FIG. 20 illustrates schematically a fifth variation in construction of the first implementation illustrated in FIGS. 1 favorite to 5 comprising skeletal blades/soul in oval format already mounted on the roll of film-flexible housing;

FIG. 21 illustrates schematically a sixth variation of construction of the first implementation illustrated in FIGS. 1 favorite to 5 comprising skeletal blades/soul in “H” format already mounted on the roll of film-flexible housing;

FIG. 22 illustrates schematically a seventh variation of construction of the first implementation illustrated in FIGS. 1 favorite to 5 comprising skeletal blades/soul in rectangular format leaked already mounted on flexible film roll-wrapper;

FIG. 23 illustrates schematically an octave variation of construction of the first implementation illustrated in FIGS. 1 favorite to 5 comprising skeletal blades/soul in another leaked already mounted in the rectangular format roll film-casing;

FIG. 24 illustrates schematically a ninth variant of construction of the first implementation illustrated in FIGS. 1 favorite to 5 comprising skeletal blades/soul in another format cross-linked rectangular already assembled on the roll of flexible film-casing;

FIG. 25 illustrates schematically a tenth variation of construction of the first implementation illustrated in FIGS. 1 favorite to 5 comprising skeletal blades/soul in rectangular shape with creases already mounted on flexible film roll-casing;

FIG. 26 illustrates schematically a eleventh variation of construction of the first implementation illustrated in FIGS. 1 favorite to 5 comprising skeletal blades/soul in rectangular format with spaces already mounted on the roll of film flexible-wrapper.

### DETAILED DESCRIPTION OF THE INVENTION

The present invention refers to a flexible laminated packaging and self-sustainable. The present invention relates to a package comprising the composition of at least one flexible film (casing), containing attached internally, externally or between films a semirigid material blade section or flexible film reinforced (skeleton/soul) smaller than the perimeter of the enclosure. This is a package that includes a structure formed from a skeleton/soul semirigid material or reinforced flexible film comprising at least one blade with pre-determined format attached to a sheath of flexible material that protects the said skeleton/soul, preferably with the perimeter of the enclosure dimensions larger than the dimensions perimeter of the skeleton/soul.

The object of the present invention comprises packing:
a structure (skeleton/soul) (1) comprising at least one blade (4) semirigid material or reinforced flexible film showing predetermined format,
casing (2) formed from a flexible material, preferably at least one flexible film;

Being that the casing (2) features perimeter dimensions larger than the dimensions of the perimeter structure (skeleton/soul) (1);

When the packing is mounted with the union of at least two opposite edges (3).

Semirigid material means, those who have an average modulus and elongation under pressure disappears completely when the pressure is removed tending to return to your original format as for example a sheet of PVC.

Still, the semirigid material or reinforced flexible film can be transparent, translucent, opaque. Besides, it can be colorless or colored and also texture.

The term flexible film usually used to describe a thin plastic material usually not more than 75 microns (0.003 inch) thick. Examples of flexible films that can be used for preparation of the sheath are: PP (polypropylene) films, films of PE (polyethylene), bioplastics and many others which form such as bags of snacks. Notwithstanding, and not limited to plastic films, are already developing cellulosic films today or even specialty papers that can be used in the future in this process.

Still, the film can be transparent, translucent flexible and/or opaque. Besides, it can be colorless or colored and also texture. May contain impressions in one of their surfaces with say about the product packaged in the package object of the present invention.

The skeleton/soul (1) can present various formats such as but not limited to: square, rectangle, Rhombus, triangle, among others. Still, the skeleton/soul (1) in alternative achievements can be leaked, corrugated, cross-linked, present relief, crease (5), among other possibilities or other characteristics of the order or providing material saving textures and shapes.

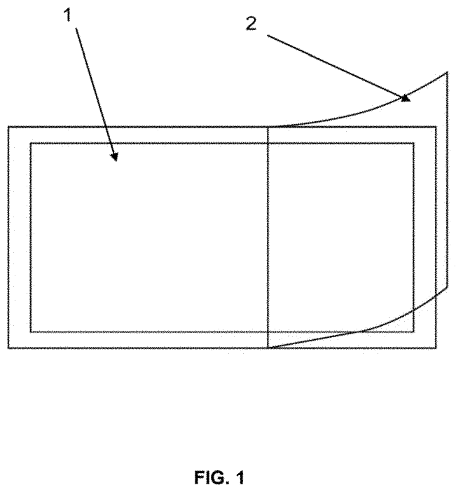

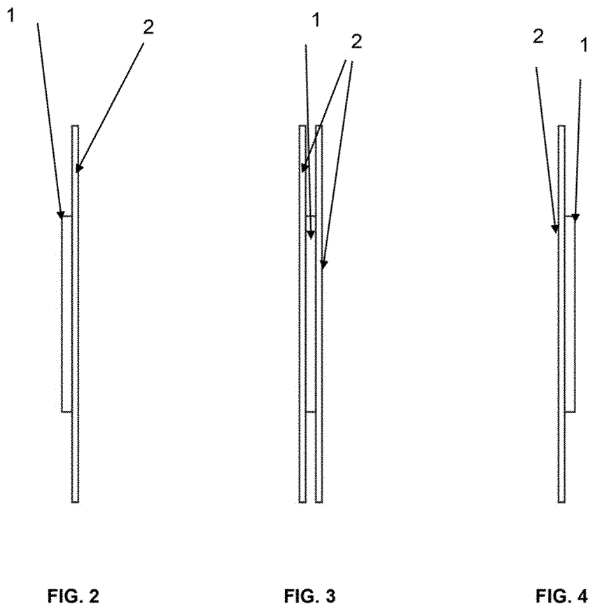

In a first realization of this favorite invention, illustrated in FIGS. 1 to 4, object of the present invention comprises an internal structure (skeleton/soul) (1) formed from a flat, dull Blade (4) of a material semirigid applied to a casing (2). The position of these two parts of the package object of the present invention can vary as can be seen from FIGS. 2 and 4. Still, the package can understand two wrappers (2) involving the internal structure or skeleton/soul (1) on both sides as can be seen from FIG. 3.

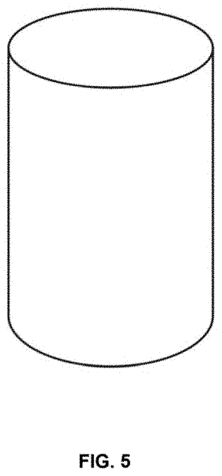

Based on this implementation choice, you can prepare the package with circular cross section forming a cylindrical-shaped packing as shown in FIG. 5.

With this same logic, it is possible to prepare packing with elliptical cross-section, for example (not illustrated in figures). Still, cross sections may have different dimensions in packing formed, resulting in a conical shaped packaging or even log-taper.

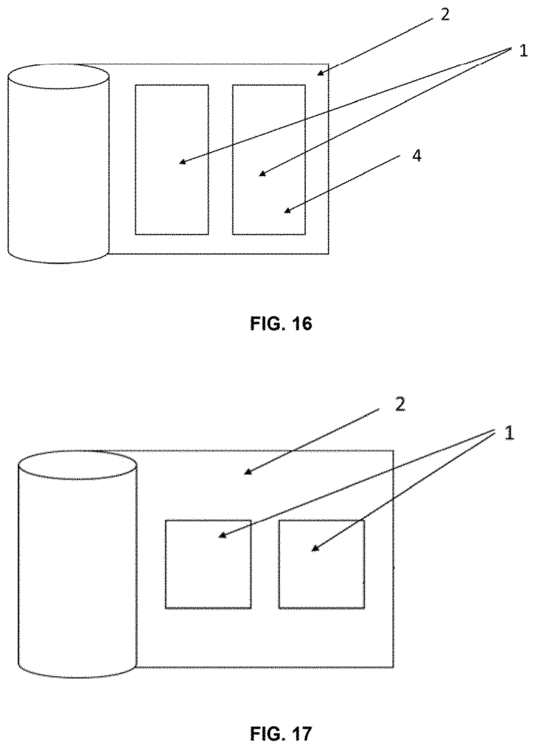

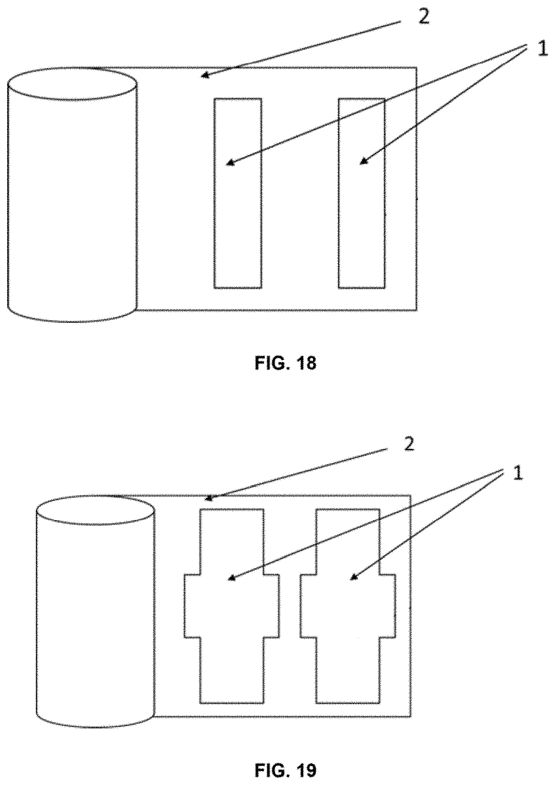

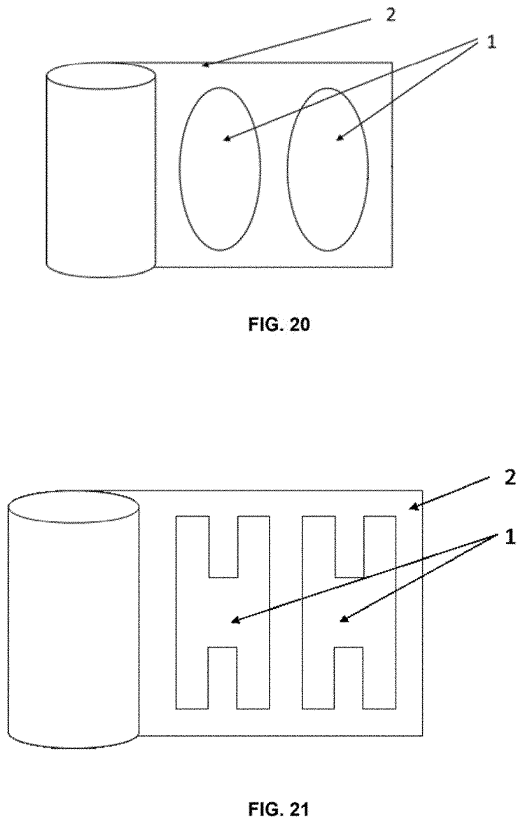

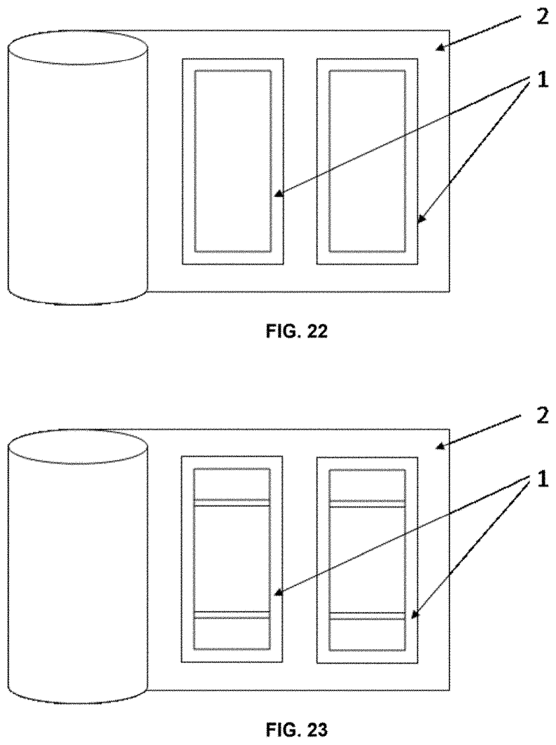

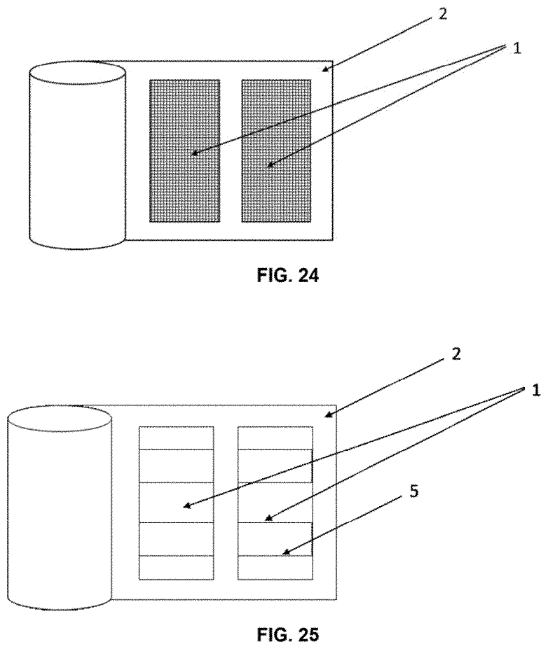

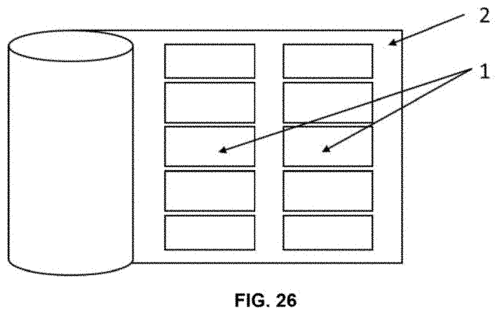

You can see from the FIGS. 16 to 25, the blades (4) may be the most different formats causing changes in the skeleton/soul (1). With these alternatives, reach different packaging formats for different uses. FIGS. 16 to 25 feature favorite examples applied to the first achievement illustrated in FIGS. 1 favorite to 5. However, these options can be applied in other favorite achievements and also in other formats mentioned here can be applied on the package object of the present invention. See if the following options:
The Figure comprises 16 (4) of the skeleton/soul (1) in a rectangular shape being flat and solid, similar to that illustrated in FIG. 1;
The Figure comprises 17 (4) of the skeleton/soul (1) in square format aimed at economy of material;
The Figure comprises 18 (4) of the skeleton/soul (1) in another rectangular shape also aimed at economy of material;
The Figure comprises 19 (4) of the skeleton/soul (1) cross-shaped also aimed at economy of material;
The Figure comprises 20 (4) of the skeleton/soul (1) oval shaped also aimed at economy of material;
The Figure comprises 21 (4) of the skeleton/soul (1) “H” also aimed at economy of material;
The Figure comprises 22 (4) of the skeleton/soul (1) rectangular format aimed at saving material also cast;
The Figure comprises 23 (4) of the skeleton/soul (1) in another format aimed at saving also cast rectangular material;
The Figure comprises 24 (4) of the skeleton/soul (1) in another rectangular shape with texture also aimed at economy of material;
The Figure comprises 25 (4) of the skeleton/soul (1) in rectangular shape with creases (5) providing different formats for packaging of the present invention;
The Figure comprises 26 (4) of the skeleton/soul (1) rectangular format containing spaces in your configuration.

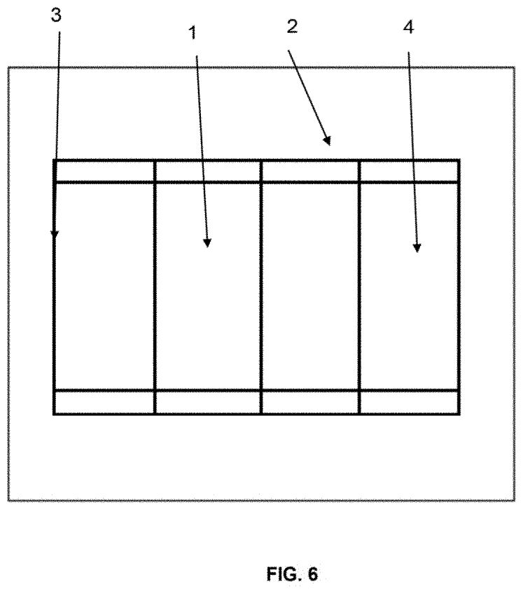

In a second implementation of this favorite invention, illustrated in FIGS. 6 to 10, object of the present invention comprises an internal structure or skeleton/soul (1) formed from a plurality of blades flat and boring (4) semirigid material or reinforced film and at least a wrapper (2) formed from flexible film. As can be seen from FIG. 6, the blades (4) skeleton/soul (1) that form the structure (1) are positioned so adjacent to each other and your total area must be less than the area of the casing (2).

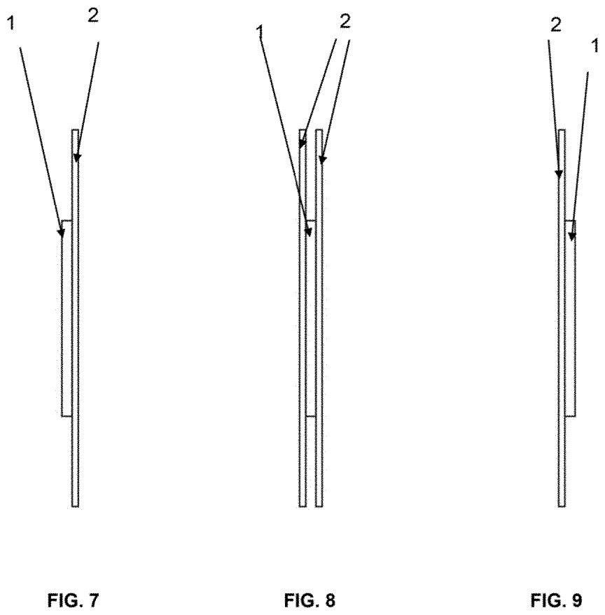

The position of these two parts of the package object of the present invention can vary as can be seen from FIGS. 7 and 9. Still, the package can understand two wrappers (2) involving the skeleton/soul (1) on both sides as can be seen from the FIG. 8.

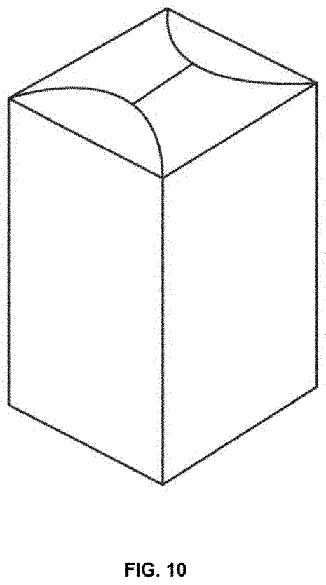

Based on this implementation choice, it is possible to prepare the casing with quadrangular cross-section forming a parallelepiped-shaped packing as shown in FIG. 10 with the composition shown in any of the 6 FIGS. 9 and the packing with the folding spans formed between the blades (4) of the skeleton/soul (1) tiled.

With this same logic, it is possible to prepare packing with rectangular cross-section or diamond or even format of polygons with 3 sides or more, for example (not illustrated in figures). The amount of sides determined in packing cross-section will be by the number of blades (4) positioned side by side forming the skeleton/soul (1). Still, cross sections may have different dimensions in packing formed, resulting in a pyramidal or prismatic shape or even trunk-trunk-prismatic or pyramidal.

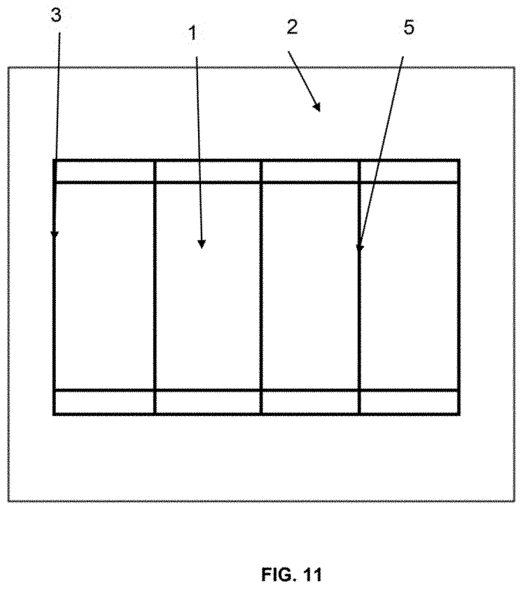

In a third favorite of this achievement, invention illustrated in FIGS. 11 to 15, object of the present invention comprises an internal structure or skeleton/soul (1) formed from a flat dull Blade (4) stiffer, or reinforced film, with creases (5) spaced and arranged in vertical direction from the packaging to be set and at least one enclosure (2) formed from flexible film. As can be seen from FIG. 11, the blade (4) that form the skeleton/soul (1) is prepared on the PCB (2) showing creases (5) arranged over the whole Blade (4) of the skeleton/soul (1).

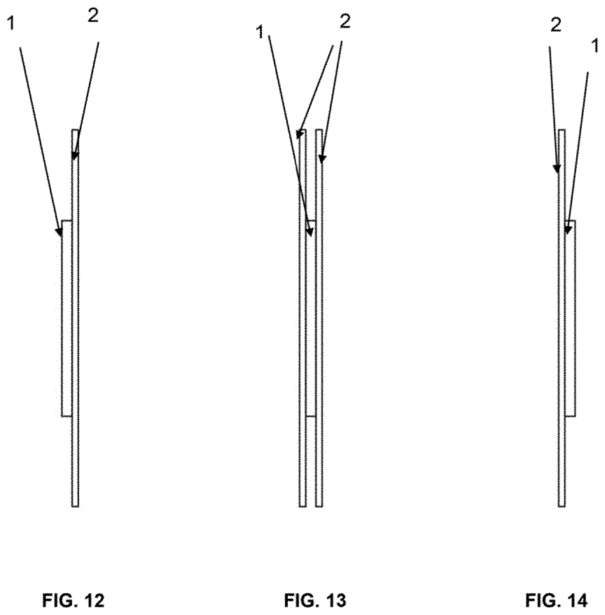

The position of these two parts of the package object of the present invention can vary as can be seen from the FIGS. 12 and 14. Still, the package can understand two wrappers (2) involving the internal structure-skeleton/soul (1) on both sides as can be seen from the FIG. 13.

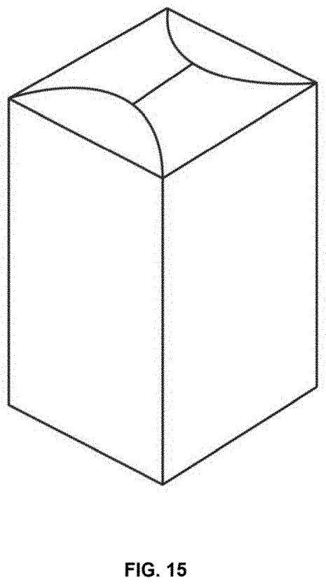

Based on this implementation choice, it is possible to prepare the casing with quadrangular cross-section forming a pack in box format as illustrated in FIG. 15 with lock the composition shown in any of the FIGS. 11 to 14 and the packing with the folding creases (5) present in the blade (4) of the skeleton/soul (1).

With this same logic, it is possible to prepare packing with rectangular cross-section or diamond or even format of polygons with 3 sides or more, for example (not illustrated in figures). The amount of sides determined in cross section of the package will be the amount of creases (5) present in the blade (4) forming the skeleton/soul (1). Still, cross sections may have different dimensions in packing formed, resulting in a pyramidal or prismatic shape or even trunk-trunk-prismatic or pyramidal.

In any one of the favorite achievements presented here or any other can be prepared from the package object of the present invention using currently known means to attach skeleton/soul (1), for example: solder, glue, tape, by interference between other fixings.

The resulting package object of the present invention can be added and incremented receiving applications in different technologies like, if, for example, as material for the sheath (2) a film-oriented polypropylene film, it is possible to provide opening the packaging for tear oriented or even through a ribbon positioned to open the package. Still, if you can apply zip resealable technologies like zipper, open-close labels, caps, among others.

The package object of the present invention is prepared from the process comprises the following steps:
Select material for preparation of at least one blade (4) that will form the structure/skeleton/soul (1);
Select material for preparation of the sheath (2);
positioning at least one blade (4) to form the frame (skeleton/soul) (1) wrapped (2) overlapping;
prepare the packaging with desired format having the casing (2) containing attached itself the skeleton/soul (1);
promote packing lock with the union of two opposite edges (3).

Such edges (3), when joined together, are parallel to the longitudinal axis of the package object from the invention. Still, the internal structure, the skeleton/soul (1), can understand that edges are the sides perpendicular to edges (3) and that can also be joined together when folding the skeleton/soul (1) in order to close it fully.

A realization of this favorite invention can be used in filling equipment of type Form Fill Seal (where the packaging is formed at the same time as the product is packed), allowing a quick and cheaper way to make a auto sustainable packaging with a high productivity with low cost and wide variety of formats and to keep the barrier characteristics and practicality of laminate film, which allows the end, a differentiated and specific design, with the possibility of stacking, in addition to increasing the physical protection to the product.

In this case, the packaging of the present invention obtained Form Fill Seal process (where the packaging is formed at the same time as the product is packed) and, more specifically, to a design of laminated composite structure and flexible to be used in the formation of self-sustaining and packaging likely stable stacking.

The present invention presents numerous technical and economic advantages when compared with the State of the art, being a few listed below:
the packaging of this invention is self-sustaining and in a single composition;
is produced with low cost;
allows your recycling after use or even reuse;
allows the packaging of any product type, solid, granulated, liquid or powdered including snacks, biscuits, disposable medical equipment and pharmaceuticals;
replaces the rigid and flexible packaging currently known;
is capable of meeting any type of industry;
is capable of stacking;
features a rigid packaging, container or receptacle package dump procedure;
comprises a structure (skeleton/soul) (1) attached to a wrapper (2) or wrap that can be prepared simultaneously;
can be made with a variety of materials, colors, shapes and dimensions;
the package itself, to understand a structure (skeleton/soul) (1) tighter than the flexible film, serves as container for serving;
may be made of recycled material;
allows the use of bioplastics;
allows immediate application in industrial park already installed to Form Fill Seal packaging machines, prevalent in most industries;

Having been described an example of an implementation of this favorite invention, it should be understood that the scope of the present invention includes other possible variations of the inventive concept described, being limited only by the content of the claims attached, including the possible equivalents.

What is claimed is:

1. Packaging particularly for packaging liquids, granulates, powder and solids characterized by understanding:
a structure (skeleton/soul) (1) formed from at least one blade (4) formed from semirigid material or reinforced film showing predetermined format;
at least a wrapper (2) formed from a flexible material that comprises at least two edges opposite substantially,
being that the casing (2) features perimeter dimensions at least substantially identical to those of the structure (1), and preferably larger than the dimensions perimeter of the internal structure-skeleton/soul (1), in which the packing is mounted with the Union of at least two edges (3) of the casing (2).

2. Packing according to claim 1 characterized by the film reinforced or semirigid material of the blade (4) of the skeleton/soul (1) preferably be a plastic that has a medium modulus and elongation under pressure disappears completely When the pressure is removed tending to return to your original format.

3. Packing according to claim 1 characterized by flexible material of the casing (2) be selected among films of PP (polypropylene), PE (polyethylene), bioplastics and many others that make up bags for example of snacks, or even cellulosic films or even specialty papers that can be used in the future in this process.

4. Packing according to claim 1 characterized by the structure (skeleton/soul) (1) be able to understand a plurality of blades (4).

5. Packing according to claim 1 characterized by the structure (skeleton/soul) (1) be formed by a blade (4) semirigid material or reinforced film containing creases (5) or be wrinkled after the junction of the structure (skeleton/soul) (1) to casing (2).

6. Packing according to claim 1 characterized by being fully closed with the Union of edges arranged perpendicularly to edges (3).

7. Packing according to claim 1 characterized by cylindrical, oval or polygonal format, example, cobblestone, prismatic, pyramidal, trunk-conical, tapered, trunk-pyramidal, prismatic-trunk.

8. Preparation process of packaging as defined in claim 1 characterized by the following steps:
Select material for preparation of at least one blade (4) will form the skeleton/structure/soul (1);
Select material for preparation of the sheath (2);
positioning at least one blade (4) to form the frame (skeleton/soul) (1) wrapped (2) overlapping;
prepare the packaging with desired format having the casing (2) containing the frame (skeleton/soul) (1);
promote packing with the closure of at least two edges (3) present in extremities of the casing (2).

9. Package characterized by being obtainable by the process as defined in claim 8.

10. Packaging according to claim 1 characterized by be to package products in powder, liquids, granulates and solids.

11. Packing according to claim 1 wherein continuous film can be rewound and used in packaging machines Form Fill Seal.
